(19) United States
(12) Patent Application Publication
(10) Pub. No.: US 2008/0307967 A1
(43) Pub. Date: Dec. 18, 2008

(54) Exhaust Gas Treatment

(75) Inventors: James Martin Coates, Cambridgeshire (GB); Alan Bhimani, Birmingham (GB)

Correspondence Address: THE OLLILA LAW GROUP LLC, 2060 BROADWAY, SUITE 300, BOULDER, CO, 80302, US

(73) Assignee: IMI Vision Limited, Warwickshire (GB)

(21) Appl. No.: 12/091,689

(22) PCT Filed: Oct. 26, 2006
(86) PCT No.: PCT/GB2006/003980

§ 371 Date: Jun. 17, 2008

(30) Foreign Application Priority Data
Oct. 26, 2005 (GB) 0521799.7

(51) Int. Cl. B01D 53/90; F01N 3/20; B01D 53/94

(52) U.S. Cl. 95/193; 96/244; 96/253; 96/251

(57) ABSTRACT

An apparatus for reducing NOx comprising an exhaust conduit (101) of an IC engine (not shown) in which is placed a urea hydrolysis reactor (102) supplied with aqueous urea from urea storage tank (103). Flow of the hot exhaust gas through the exhaust conduit (101) heats the reactor (102) and causes the temperature of the urea therein to rise, promoting its hydrolysis and producing gaseous hydrolysis products. A pressure control valve (106) controls the release of the gaseous hydrolysis products from the reactor to a condenser (107). The condenser (107) is provided with a heat exchanger (108) which has an inlet (109) and an outlet (110) for connection to a coolant supply. When the gaseous hydrolysis gas enters the condenser (107) it is cooled by heat exchange with the engine cooling fluid and the ammonia and steam condense to form a pool of liquid in the bottom of the condenser (107). A dosing valve (112) is provided in the bottom of the condenser (107) to dose the liquid condensate into the exhaust conduit (101) to pass with the exhaust gas through an SCR catalyst on the surface of which the ammonia reacts with the Nox.

The present invention relates to a method of, and an apparatus for, reducing emissions of Nitrogen oxides (NOx) in exhaust gasses of an internal combustion (IC) engine.

The introduction of either ammonia or an ammonia precursor into the flow of an exhaust gas of an IC engine prior to the gas passing through a catalyst in order to effect selective catalytic reduction (SCR) of NOx is well known.

NOx reduction is becoming required on commercial vehicles as legislation controlling emissions are becoming even more stringent and it is widely accepted in the vehicle industry within Europe that aqueous urea is the most appropriate precursor. A number of systems for dosing aqueous urea into the exhaust have been proposed. These systems, known as “wet spray” systems inject a spray of aqueous urea into the exhaust gas stream where it decomposes to form ammonia. While the system works there are concerns as to its longevity because a by-product of the urea decomposition are solid deposits which form in the injector nozzle eventually blocking it or may collect on the SCR catalyst, covering its surface and rendering it less effective resulting in a reduced performance and eventually a need for replacement.

An alternative is a gas based-system, with ammonia gas being produced and introduced into the exhaust gas as it is needed. However, these systems need complex controls to achieve accurate dosing in a changing thermal environment. Wet spray systems, however, can simply and repetitively dose a constant amount independent of thermal environment.

The present invention attempts to mitigate the above problems by providing a urea-based wet spray system that eliminates problem associated with solid decomposition products.

According to one aspect of the present invention there is provided a method of effecting selective catalytic reduction (“SCR”) of NOx present in the exhaust gas of an IC engine, the method comprising:
a) hydrolysing, at an elevated temperature and pressure, an aqueous solution of urea into a gaseous hydrolysis product comprising ammonia, carbon dioxide and steam;
b) condensing the gaseous hydrolysis product into an aqueous condensate;
c) at least temporarily storing a volume of the aqueous condensate; and
d) feeding the stored aqueous condensate into the exhaust gas upstream of an SCR catalyst.

According to another aspect of the present invention, there is provided an apparatus for generating and feeding an aqueous ammonia containing solution, formed by the condensation of gasses formed by hydrolysis of an aqueous solution of urea at elevated temperature and pressure, into the exhaust gas of an IC engine as it flows through the exhaust system of the engine, comprising:
a) a reaction vessel adapted to be located at least partially within the exhaust system of the engine for containing an aqueous solution of urea and arranged such that, in use, the vessel and therefore the urea solution become heated by means of heat exchange with the exhaust gas as it flows through the exhaust system;
b) a urea solution inlet to the reaction vessel and a gaseous hydrolysis product outlet from the reaction vessel;
c) a condenser means for condensing the gaseous hydrolysis product into an aqueous ammonia-containing condensate and for temporarily storing said condensate;
d) a valve in the outlet from the reaction vessel and adapted to cause the contents of the reaction vessel, in use, to attain an elevated pressure as it becomes heated, and periodically to discharge gaseous hydrolysis product into the condenser; and
e) a conduit for interconnecting the condenser and the exhaust system, the conduit including valve means to selectively control the feed of said condensate stored in the condenser into the exhaust gas via the conduit.

Preferably the reactor vessel is located fully within the exhaust gas flow such that its entire surface area is substantially exposed to the hot exhaust gas.

Preferably the reactor vessel is the reactor vessel described in our co-pending international patent application WO 2006/087551 and operates as described therein.

The valve in the outlet from the reaction vessel and adapted to cause the contents of the reaction vessel, in use, to attain an elevated pressure as it becomes heated, and periodically to discharge gaseous hydrolysis product into the condenser, may take a number of forms.

In one preferred arrangement the valve actuates in response to a signal generated in response to a measured pressure in the reaction vessel. Alternatively the valve can be self-actuating when a preset pressure occurs on its inlet side, i.e. it may be a simple mechanical back pressure valve. In an alternative preferred arrangement the valve actuates in response to a measured temperature of the aqueous urea solution in the reaction vessel. As the reaction occurs within the reaction vessel and the pressure rises the temperature within the solution also rises until both are elevated, control of the release of the gaseous hydrolysis product can be based on either.

Preferably the apparatus further comprises a cooling circuit, for cooling the condenser, through which a cooling fluid flows and heat exchange means to remove heat from the cooling fluid.

In a preferred arrangement the cooling fluid is the engine cooling fluid. Alternatively the cooling fluid may be the engine lubricant fluid. Preferably the flow of cooling fluid is controllable to maintain a substantially constant temperature within the condenser.

In an alternative embodiment the cooling is achieved by direct air cooling of the condenser. Preferably where direct air cooling is used the condenser has a plurality of fins thereon to promote heat exchange with the air passing thereover. In a preferred arrangement the apparatus may be provided with a cooling fan to force air over the exterior of the condenser. Where the apparatus is used on a commercial vehicle it further comprises a duct adapted to funnel a flow of air over the condenser as the vehicle moves.

The gaseous hydrolysis product contains ammonia, carbon dioxide and steam. As the hot gas enters the condenser it cools and the water and ammonia condense to form a liquid which collects in the base of the condenser. Preferably at least a proportion of the carbon dioxide remains in its gaseous state in the condenser and is preferably periodically vented from the condenser. Preferably the carbon dioxide is vented from the reservoir by means of a pressure control valve. Preferably the pressure control valve is operable to maintain the pressure within the condenser in a slightly elevated state to assist the dosing of the liquid condensate from the bottom of the condenser.

Preferably the elevated pressure within the condenser is maintained below 4 bar, more preferably below 2 bar.

Preferably the condenser has an outlet leading to said conduit at its lower end and through which condensate is ejected by the elevated pressure within the condenser when said valve means to selectively control the feed of said condensate stored in the condenser into the exhaust gas is opened.

Preferably, in use, the condenser is maintained above the temperature at which solid salts start to form, and below the temperature at which water condenses at the prevailing pressure within the condenser.

In one preferred arrangement the cooling circuit comprises a cooling coil within the condenser. In an alternative preferred arrangement the condenser comprises a tube-in-tube heat exchanger through which the cooling fluid passes to cool the gas therein causing it to condense.

Preferably the condenser inlet for the gaseous hydrolysis product is situated in its lower end of the condenser such that, once there is some condensate stored in the condenser, the gaseous hydrolysis product is forced to pass through said condensate on entering the condenser. Preferably, when the condenser inlet is situated in the lower end of the condenser, a baffle is provided to prevent gaseous hydrolysis product entering the condenser from mixing with the liquid condensate being dosed into the exhaust gas. Preferably the baffle is substantially vertical and is made of a fine mesh to allowing liquid condensate to flow therethrough but prevent the passage of gaseous hydrolysis product.

In a preferred arrangement the exterior of the entire condenser is temperature controlled by heat exchange. This may be achieved directly by heat exchange with the engine cooling or lubrication system.

As, in accordance with the invention, condensed urea hydrolysis product is added, rather than urea itself, to the exhaust conduit, problems of solid deposit formation associated with the rapid pyrolysis of urea are avoided while still utilising aqueous urea as a starting product. In addition, problems associated with variable pressures in volumetric dosing of gasses are avoided.

Embodiments of the invention will now be described, by way of example only, with reference to the accompanying drawings in which:

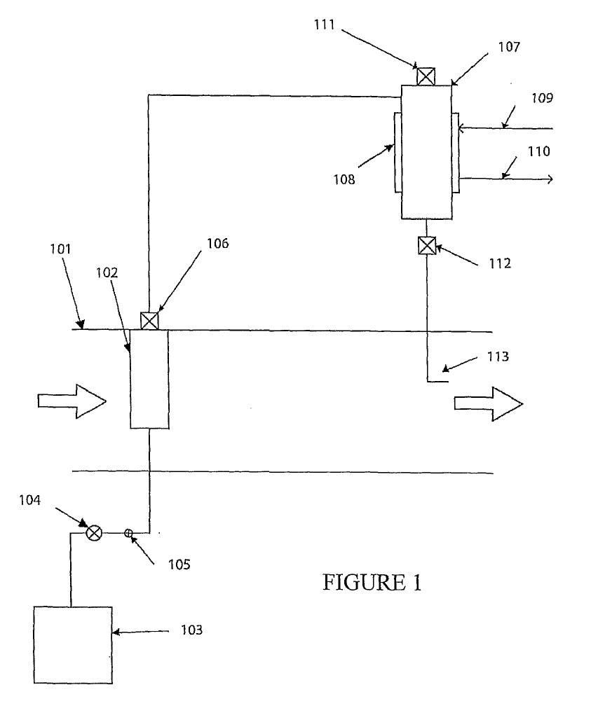

FIG. 1 is a diagram of an apparatus of the invention;

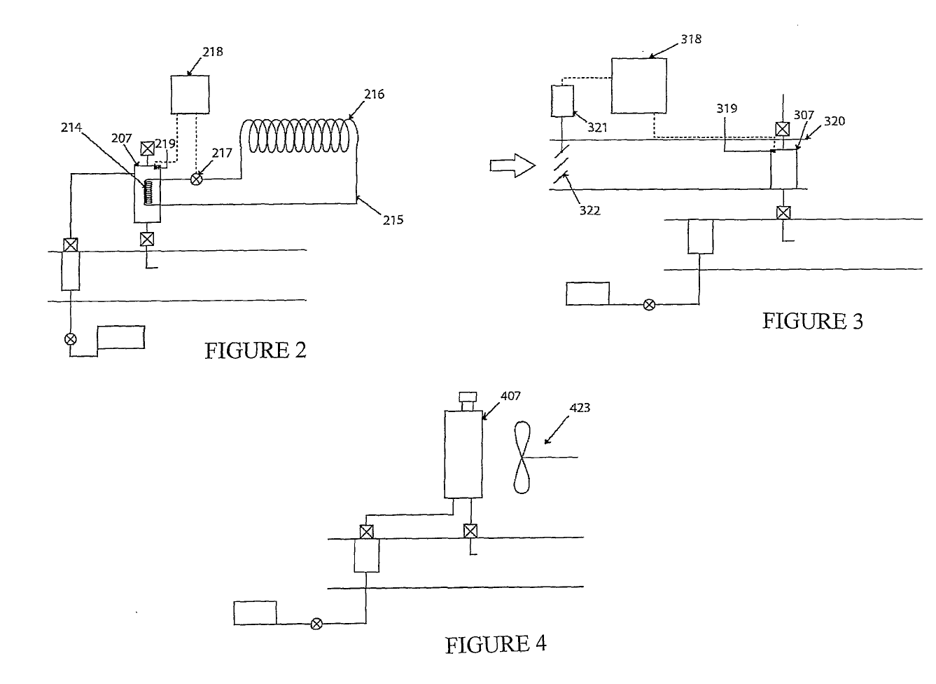

FIG. 2 is a diagram of an apparatus of the invention having its own coolant circuit for cooling the condenser;

FIG. 3 is a diagram of an apparatus of the invention having ducting for effecting direct air cooling of the condenser;

FIG. 4 is a diagram of an apparatus of the invention which utilises forced air cooling of the condenser;

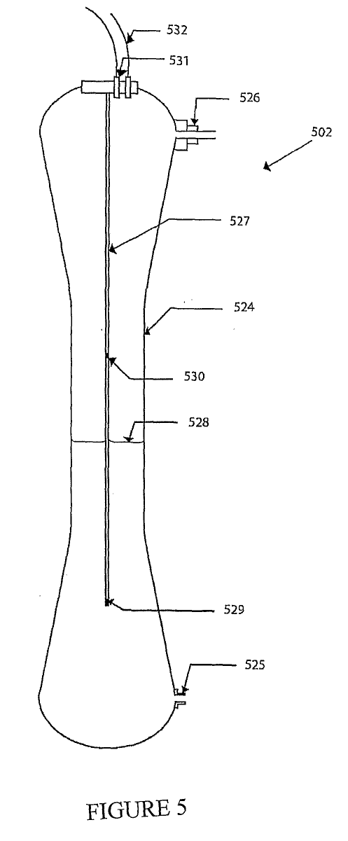

FIG. 5 is a cross section of a reaction vessel suitable for use in the invention;

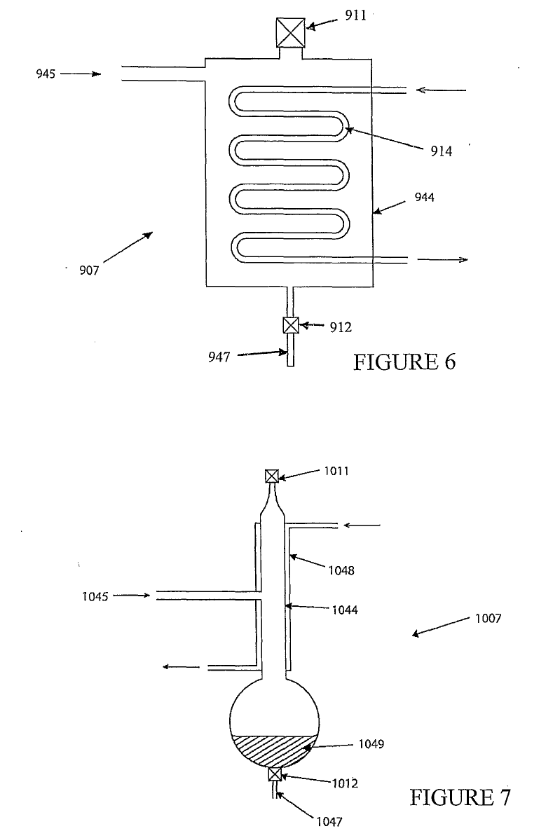

FIG. 6 is diagram of a condenser having a cooling coil;

FIG. 7 is a diagram of a condenser having a tube-in-tube heat exchanger; and

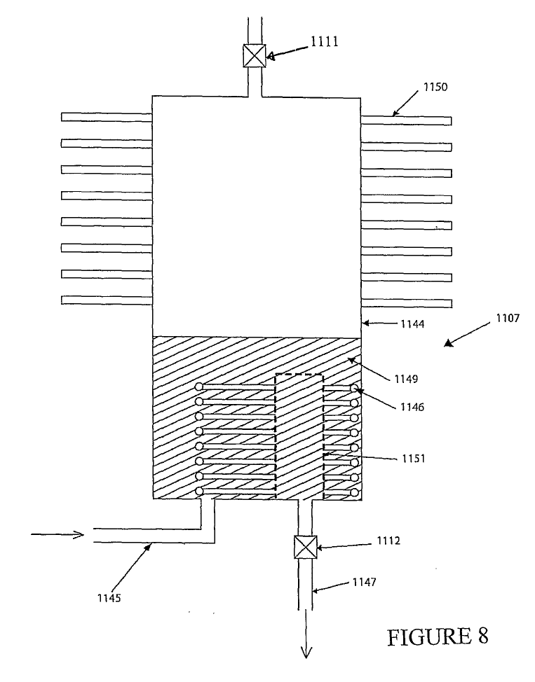

FIG. 8 is a diagram of a condenser with a gas separation baffle.

Referring to FIG. 1 an apparatus is shown comprising an exhaust conduit 101 of an IC engine (not shown) in which is placed a urea hydrolysis reactor 102 which is supplied with aqueous urea from urea storage tank 103 by pump 104 via check valve 105. Flow of the hot exhaust gas through the exhaust conduit 101 heats the reactor 102 and causes the temperature of the urea therein to rise, promoting its hydrolysis and producing gaseous hydrolysis products. A pressure control valve 106 controls the release of the gaseous hydrolysis products from the reactor and operates such that an elevated pressure is affected within the reactor. An outlet from the pressure control valve 106 enters condenser 107 bleeding any excess gaseous hydrolysis product above a set pressure into the condenser 107. The condenser 107 is provided with a heat exchanger 108 which has an inlet 109 and an outlet 110 for connection to a coolant supply. The coolant supply is the engines cooling system. When the gaseous hydrolysis gas enters the condenser it is cooled by heat exchange with the engine cooling fluid by the heat exchanger 108 and the ammonia and steam condense to form a pool of liquid in the bottom of the condenser. A pressure relief valve 111 is provided in the top of the condenser for releasing the proportion of carbon dioxide that remains in gaseous form at the temperatures within the condenser. A dosing valve 112 is provided in the bottom of the condenser to dose the liquid condensate into the exhaust conduit 101 via nozzle 113. Due to the temperature of the exhaust gas the condensate is quickly converted back to its gaseous form, the ammonia gas and steam passing with the exhaust gas through an SCR catalyst (not shown) on the surface of which the ammonia reacts with the NOx in the gas thereby converting it to less harmful compounds.

Referring to FIG. 2 the apparatus of FIG. 1 is shown further comprising a condenser coil 214 within the condenser 207, said condenser coil 214 being connected via a coolant circuit 215 to a heat exchanger 216 to cool the coolant fluid by means of heat exchange with the atmosphere. The apparatus is further provided with a variable pump 217 which is controlled via controller 218 in response to the temperature measured within the condenser 207 by sensor 219.

Referring to FIG. 3, the apparatus of FIG. 1 is shown further comprising a cooling conduit 320 through which air flows to pass over the exterior of, and therefore cool, the reactor 307 which is placed in the conduit. Temperature within the condenser measured by sensor 319 is used by controller 318 to vary the flow through the cooling conduit 320 by means of driving a motor 321 which controls variable flow louvers 322 to control the temperature within the condenser 307. When the engine is associated with a mobile application, for example a vehicle, the movement of the vehicle is used to push the air through the cooling conduit

Referring to FIG. 4, the apparatus of FIG. 1 is shown further comprising a cooling fan 423 which forces an air flow over the condenser 407 cooling its outer surface and aiding condensation of the ammonia gas carbon dioxide and steam therein.

Referring to FIG. 5 a reactor 502 suitable for use in the apparatus of the invention is shown comprising an elongate body 524 with a bulbous upper and lower region. The reactor is provided with an inlet 525 for the supply of aqueous urea solution and an outlet 526 for the removal of the ammonia-containing gas. The release of the ammonia-containing gas via the outlet is controlled by a pressure control valve in the outlet line (not shown). Entering the reservoir from the top is a level sensor 527, the output of which is used to control a pump (not shown) in the urea inlet line to maintain the urea liquid level 528 between lower 529 and upper 530 liquid level measurement points. Also entering the top of the reactor are a pressure sensor 531 and temperature sensor 532. In use, the reactor is heated at least partially by thermal heat transfer with hot exhaust gas. A reactor of this design is particularly appropriate for use in a mobile application, for example on board commercial vehicle as, due to its tall thin geometry the liquid level will remain substantially unaffected by such factors as the vehicle being on an incline, centrifugal force of the vehicle following a radial path or the reagent moving about due to uneven motion of the vehicle. All the sensors 527, 531, 532 comprise a single sub assembly which is attached to the reactor at one end, thereby giving a single access point enabling simple replacement should any of the sensors fail.

Referring to FIG. 6 a condenser 907 for use in the system of the invention is shown comprising a body 944 with an inlet 945 for the gaseous hydrolysis product and an outlet 947 for condensed product. Situated within the body 944 is a condenser coil 914 through which the coolant fluid circulates. A pressure control valve 911 releases excess carbon dioxide from the condenser and a dosing valve 912 in the outlet 947 is operable to dose the condensed product into the exhaust conduit.

Referring to FIG. 7 an alternative condenser for use in a system of the invention is shown having a gaseous hydrolysis product inlet 1045 and condensed product outlet 1047 leading to an injection nozzle (113 FIG. 1). Surrounding the body 1044 of the condenser 1007 is a coolant fluid jacket 1048, said body 1044 and coolant fluid jacket 1048 extending below and above the fluid inlet 1045. The body 1044 has a pressure control valve 1011 which releases excess carbon dioxide from the condenser. The gaseous hydrolysis product enters the condenser at inlet 1045 and condenses as a result of heat transfer to the coolant fluid flowing within the coolant jacket 1048. The condensed gasses (ammonia, carbon dioxide and water) 1049 collect in the bottom of the condenser and are selectively dosed into the exhaust via dosing valve 1012 and outlet 1047.

Referring to FIG. 8, an alternative form of condenser 1107 for use in a system of the invention is shown having a gaseous hydrolysis product inlet 1145 and condensed product outlet 1147 controlled by dosing valve 1112 leading to an injection nozzle (113 FIG. 1). Both the inlet 1145 and the outlet 1147 are located in the bottom of the reservoir 1107. The reservoir has a condenser coil 1146 in its lower section which is connected to a source of cooling fluid as described herein. The condensate 1149 collects in the lower section of the condenser 1107 and is cooled by the flow of coolant fluid through condenser coil 1146. The body 1144 of the condenser has cooling fins 1150 attached thereto to promote the cooling of the walls of the upper section of the condenser 1107. Situated at the top of the condenser 1107 is a pressure control valve 1111 which is operable to allow any excess CO₂ to escape from the condenser 1107. Situated in the lower section of the condenser 1107 is a baffle 1151 which separates a volume of condensate 1149 adjacent to the outlet from the remainder of the condensate 1149. Thus, as gaseous hydrolysis product enters the condenser 1107 via the inlet 1145 it passes through the condensate 1149 which rapidly cools it causing some of it to immediately condense and mix with the condensate already in the condenser. The remainder of the gaseous hydrolysis product will bubble through the condensate 1149 and collect in the condenser 1107 above the level of the condensate where it will condense on the walls 1144 of the condenser 1107 which are cooled, via fins 1150, by heat exchange with the external environment, which may comprise a forced air flow. The baffle 1151 prevents gas entering the condenser from immediately exiting the outlet 1147 in gaseous form when the valve 1112 is open, by preventing the gas from flowing into the area of condensate adjacent to the outlet 1147.

What is claimed is:

1 A method of effecting selective catalytic reduction (“SCR”) of NOx present in the exhaust gas of an IC engine, the method comprising:
a) hydrolysing, at an elevated temperature and pressure, an aqueous solution of urea into a gaseous hydrolysis product comprising ammonia, carbon dioxide and steam;
b) condensing the gaseous hydrolysis product into an aqueous condensate;
c) at least temporarily storing a volume of the aqueous condensate; and
d) feeding the stored aqueous condensate into the exhaust gas upstream of an SCR catalyst.

2 An apparatus for generating and feeding an aqueous ammonia containing solution, formed by the condensation of gasses formed by hydrolysis of an aqueous solution of urea at elevated temperature and pressure, into the exhaust gas of an IC engine as it flows through the exhaust system of the engine, comprising:
a) a reaction vessel adapted to be located at least partially within the exhaust system of the engine for containing an aqueous solution of urea and arrange such that, in use, the vessel and therefore the urea solution become heated by means of heat exchange with the exhaust gas as it flows through the exhaust system;
b) a urea solution inlet to the reaction vessel and a gaseous hydrolysis product outlet from the reaction vessel;
c) a condenser means for condensing the gaseous hydrolysis product into an aqueous ammonia-containing condensate and for temporarily storing said condensate;
d) a valve in the outlet from the reaction vessel and adapted to cause the contents of the reaction vessel, in use, to attain an elevated pressure as it becomes heated, and periodically to discharge gaseous hydrolysis product into the condenser; and
e) a conduit for interconnecting the condenser and the exhaust system, the conduit including valve means to selectively control the feed of said condensate store in the condenser into the exhaust gas via the conduit.

3 The apparatus according to claim 2 wherein the reaction vessel is located filly within the exhaust gas flow such that an entire surface area of the reaction vessel is substantially exposed to the hot exhaust gas.

4 The apparatus according to claim 2 wherein the valve in the outlet of the reaction vessel actuates in response to a signal generated in response to a measured pressure in the reaction vessel.

5 The apparatus according to claim 2 wherein the valve in the outlet of the reaction vessel is self-actuating when a preset pressure occurs on an inlet side of the reaction vessel.

6 The apparatus according to claim 2 wherein the valve in the outlet of the reaction vessel is actuated in response to a measured temperature of the aqueous urea solution in the reaction vessel.

7 The apparatus according to claim 2 further comprising a cooling circuit, for cooling the condenser, through which cooling circuit a cooling fluid flows, and heat exchange means to remove heat from the cooling fluid.

8 The apparatus according to claim 7 wherein the cooling fluid is the engine cooling fluid.

9 The apparatus according to claim 7 wherein the cooling fluid is the engine lubricant fluid.

10 The apparatus according to claim 7 wherein the flow of the cooling fluid is controlled to maintain a substantially constant temperature within the condenser.

11 The apparatus according to claim 2 wherein the condenser is cooled by air cooling of the condenser.

12 The apparatus according to claim 11 wherein the condenser has a plurality of external fins thereon to promote heat exchange with the air passing thereover.

13 The apparatus according to claim 11 further comprising a cooling fan to force air over the exterior of the condenser.

14 The apparatus according to claim 11 when used on a commercial vehicle comprising a duct adapted to funnel a flow of air over the condenser as the vehicle moves.

15 The apparatus according to claim 2 wherein at least a proportion of carbon dioxide of the gaseous hydrolysis product remains in a gaseous state in the condenser.

16 The apparatus according to claim 15 wherein carbon dioxide is vented from a reservoir of the reaction vessel by means of a pressure control valve operable to maintain a slightly elevated pressure within the condenser.

17 The apparatus according to claim 16 wherein the pressure within the condenser is below about 4 bar.

18 The apparatus according to claim 16 wherein the pressure within the reactor is below about 2 bar.

19 The apparatus according to claim 2 wherein the condenser has an outlet leading to said conduit at a lower end of the condenser and through which condensate is ejected by the elevated pressure within the condenser when said valve means to selectively control the feed of said condensate stored in the condenser into the exhaust gas is opened.

20 The apparatus according to claim 7 wherein the cooling circuit comprises a cooling coil within the condenser.

21 The apparatus according to claim 7 wherein the condenser comprises a tube-in-tube heat exchanger through which the cooling fluid passes to cool the gas therein causing it to condense.

22 The apparatus according to claim 2 wherein a condenser inlet for the gaseous hydrolysis product is situated in a lower end of the condenser such that once there is some condensate stored in the condenser, the gaseous hydrolysis product is forced to pass through said condensate on entering the condenser.

23 The apparatus according to claim 2 wherein a baffle is provided to prevent gaseous hydrolysis product entering the condenser from mixing with the condensate being dosed into the exhaust gas.

24 The apparatus according to claim 23 wherein the baffle is substantially vertical and is made of a fine mesh to allow liquid condensate to flow substantially therethrough but substantially preventing the gaseous hydrolysis product from flowing sideways through the baffle.
